(19) United States
(12) Patent Application Publication
(10) Pub. No.: US 2024/0289041 A1
(43) Pub. Date: Aug. 29, 2024

(54) FORMAT CONVERSION POLICY IN CLOUD OBJECT STORAGE

(71) Applicant: INTERNATIONAL BUSINESS MACHINES CORPORATION, Armonk, NY (US)

(72) Inventors: Charan Acharya Chandrashekar, Bangalore (IN); Srikkanth R Kulkarni, Bengaluru (IN); Shrinidhi Kulkarni, Bengaluru (IN)

(21) Appl. No.: 18/114,342

(22) Filed: Feb. 27, 2023

(51) Int. Cl. G06F 3/06

(52) U.S. Cl. CPC G06F 3/064; G06F 3/0604; G06F 3/067

(57) ABSTRACT

A computer-implemented method, a system, and a computer program product for cloud object storage format conversion are provided. A processor identifies a target object format and an object storage bucket in a COS environment. The processor determines a function associated with objects in the storage bucket. The processor generates a conversion policy that includes converting a first format of an object to a target format, based on the function, the object storage bucket, the first format, and input from a user. The processor receives a request to perform the function on a object having a first format and an object storage bucket corresponding to performing the function on the object, and the processor triggering conversion of the object having the first format to the target format within the cloud environment, based on the conversion policy for the object storage bucket.

### BACKGROUND

The present disclosure relates generally to the field of cloud object storage and, more specifically, to a format conversion of objects for cloud object storage.

Cloud storage is a computing model enabling the storage of data and files on the Internet through a provider that provides access to storage resources through the public internet or a dedicated private network connection. The provider manages and maintains the hardware and software resources and infrastructure and provides nearly unlimited scalability and elastic capability.

Three types of cloud storage are recognized, object storage, file storage, and block storage. Each type of cloud storage differs from the others and offers a respective set of advantages and disadvantages. File storage employs a folder hierarchy structure that provides an organized schema; however, as data volume grows increasing resource demands to keep track of folder and file structures may affect performance. Block storage is based on a fixed size “chunk” or “blocks” of data, independent of individual files or objects, such that files may be stored across multiple blocks or multiple files may be stored within a single block, depending on the selected block size. Block storage is efficient but has limited capability to handle metadata.

Object storage architecture is commonly used and includes flat, unstructured architecture. Object storage includes an addressing scheme that often utilizes object names as “keys” in lookup tables, simplifying and expediting access to a stored object. Object storage is most commonly used for large stores of unstructured data, often storing data in a format in which it is received and includes enabling customizable metadata for facilitated access. Objects stored in cloud object storage (COS) are often stored in “buckets” and are associated with a unique identifier. Objects in cloud storage are typically accessed using application programmable interfaces (APIs) or representational state transfer (REST) interfaces. Two important functionalities supported by cloud object storage include uploading objects to cloud storage and downloading objects from cloud storage.

A user may wish to maintain a common format for all objects stored in a cloud storage bucket, which may be based on hardware or application compatibility or consistency for sharing of an object among multiple users. Currently, if users wish to convert objects to a common format the conversion is required to be performed on an individual basis and prior to upload to cloud storage, or subsequent to downloading objects of varying formats from cloud storage. To perform object format conversions, users must rely on third-party converters or access and use of a conversion application. Users may need to configure individual conversion applications and integrate the conversion application with upload and download application features of the cloud storage infrastructure.

In other cases, an object of a particular format to be stored in cloud object storage may need to be converted into multiple instances, each having a different format. For example, an object that is used by multiple users, each with different applications and/or hardware that requires particular formatting, would require storage of the object in various formats in cloud storage, even though the original object was of a single format. Under current conditions, the object would require independent conversion of the subject object to each of the formats needed prior to each upload function, then accessing the cloud environment for upload of the individually formatted objects to COS.

Users assuming object format when downloading objects from cloud storage are impacted in efficiency and performance using the object due to required format conversions before the object can be used. Similarly, users uploading objects of one format are impacted when required to include multiple formats of the object, which require manual conversion and additional upload tasks.

### SUMMARY

Embodiments of the present disclosure include a computer-implemented method, system, and computer program product for cloud object storage format conversion. A processor may identify an object storage bucket and a target object format for objects stored in the object storage bucket of a cloud environment. The processor may determine a function that is associated with objects stored in the object storage bucket of the cloud environment. The processor may receive input from an authorized user or administrator of the object storage bucket which is used by the processor to set a conversion policy for the object storage bucket. The conversion policy includes information for converting an object having a first format to the object having a target format and is based on the function to be performed, the object storage bucket, and the input received from the authorized user or administrator of the storage bucket. The processor may receive a request to perform the function for an object having a first format, wherein the first format and the target format are different formats, and the processor may trigger the generation of a conversion of the object having the first format to the target format, within the cloud environment, based on the function requested and the conversion policy for the object storage bucket of the cloud environment.

The conversion policy, as proposed by the inventors of the present disclosure and set by an authorized user or administrator for one or more object storage buckets of a COS environment (herein, also referred to as a/the cloud environment), provides for consistency in object format storage, flexibility in format options, and removes compatibility issues. The current practice of object format conversion is performed at an individual level and external to the cloud environment, which encourages inconsistency, requires manual designation of operations, may require multiple copies and licensing of conversion applications and prevents linkage of multiple instances of different formats by use of metadata of a stored object for maintaining consistent update information. Additionally, the present disclosure initiates the appropriate format conversion operation based on the determined function received, providing optional conversion operations for upload and download functions to an object storage bucket of the cloud environment. The present disclosure includes an error handling aspect for incompatible conversion and maintains consistency in object update operations by linking instances of stored objects of dissimilar formats.

In some embodiments, an advantage is attained by the processor determining the function to be an upload operation of a object, based on a received request in which the object has a first format, to an object storage bucket of the cloud environment, in which the processor triggers the conversion of the first format of the object to a target format, prior to processing the object for storage in the object storage bucket. The conversion policy for a storage bucket of the cloud environment can serve upload operations and provide the advantage of performing the format conversion within the cloud environment.

In some embodiments, an advantage is attained by the processor determining the function to be a download operation of the object, based on a received request, in an object storage bucket of the cloud environment having a first format in which the processor triggers the conversion of the first format of the object to a target format subsequent to processing the object for download but before initiating the download to a requesting user. The conversion policy for a storage bucket of the cloud environment can provide an advantage in serving download operations that convert the first format of the object to a target format subsequent to retrieval and processing of the first object from storage (i.e., a copy of the object), by performing the conversion within the cloud environment.

In some embodiments, an advantage is attained by the processor triggering the generation of a “one-to-many” conversion of the object having a first format. The processor may trigger multiple converters that collectively generate multiple instances of the object into instances of the object with respective formats, based on the conversion policy associated with the object storage bucket of the cloud environment. The enablement of conversion of an object format to multiple instances of the object each having a different format type is an advantage for accommodating multiple hardware and software makes and versions by a plurality of users that otherwise may need to make costly retooling purchases.

In some embodiments, an advantage is attained by the processor triggering the conversion of a plurality of objects that have a plurality of formats, respectively, to the plurality of objects with each having a target format. The processor performs an “any-to-one” conversion of object formats, performing conversions within the cloud environment and avoiding multiple or repetitive instances of conversion operations.

In some embodiments, an advantage is attained by the processor linking a plurality of instances of the object with respective format types from the one-to-many format conversions of the object by metadata associated with each instance of the plurality of instances of the object. The processor checks the metadata to determine hard-linked objects prior to performing operations on an object, providing the advantage of maintaining the consistency of object instances that have varying formats. In some embodiments, detection of hard-linked objects prior to performing an operation on one of the linked objects may produce an alert or present options to a user for how to proceed.

In some embodiments, an advantage is attained by the processor receiving a request in which the function requested is a download request of the object and the download request includes a format conversion request from the first format to the target format, wherein the conversion is performed within the cloud environment prior to performing the download and the target format is selected from options of format conversion included in the conversion policy.

In some embodiments, an advantage is attained by the processor receiving a request in which the function requested is an upload request of the object and the upload request includes a format conversion request from the first format to the target format, wherein the conversion is performed within the cloud environment prior to processing the object for storage in an object storage bucket and the target format is selected from options of format conversion included in the conversion policy.

An aspect of the disclosure includes an error-handling mechanism for incompatible format detection. In some embodiments, an object format detected during an upload or download request of cloud object storage is determined to be incompatible with conversion types recognized by the conversion policy for an object storage bucket. The disclosure includes a set of actions presented for a selection by the requesting user as a result of the detected incompatible conversion. The actions for selection may be set during conversion policy implementation and may include options to skip the operation (ignore), delete the object, or move the storage of the object to a particular storage bucket.

An aspect of the disclosure includes the definition and rules associated with a conversion policy to be set by an authorized user and includes the assignment of the conversion policy to one or more object storage buckets within the cloud environment. Conversion policies can designate what actions to take for the conversion of a single object from an existing format to a target format, or to multiple instances of target formats, performing the conversion operation within the cloud object storage environment, prior to storage processing for upload requests and prior to initiating download of the converted object(s) to the requesting source.

The above summary is not intended to describe each illustrated embodiment or every implementation of the present disclosure.

### BRIEF DESCRIPTION OF THE DRAWINGS

The drawings included in the present disclosure illustrate embodiments of the present disclosure and, along with the description, serve to explain the principles of the disclosure. The drawings are only illustrative of some embodiments and do not limit the disclosure.

FIG. 1 depicts a schematic diagram of a computing environment for executing program instructions related to the methods disclosed herein and for format conversion of an object while performing a function within a cloud environment, according to at least one embodiment.

FIG. 2A is a block diagram illustrating an example of object format conversion within a cloud environment for an object upload function, in accordance with some embodiments of the present disclosure.

FIG. 2B is a block diagram illustrating an example of object format conversion within a cloud environment during an object download function, in accordance with some embodiments of the present disclosure.

FIG. 3 illustrates an example process flow for object format conversion within a cloud environment, in accordance with some embodiments of the present disclosure.

While the embodiments described herein are amenable to various modifications and alternative forms, specifics thereof have been shown by way of example in the drawings and will be described in detail. It should be understood, however, that other modifications, alternatives, and embodiments are possible, falling within the spirit and scope of this disclosure and the particular embodiments described herein are not to be considered limiting.

### DETAILED DESCRIPTION

Aspects of the present disclosure relate to the field of cloud object storage (COS) and, more particularly, to dynamically converting the format of an object within a cloud environment, during an upload or download function, based on a conversion policy associated with the function performed and the storage bucket within the cloud environment. While the present disclosure is not necessarily limited to such applications, various aspects of the disclosure may be appreciated through a discussion of various examples using this context.

Embodiments of the present invention recognize that none of the cloud object storage providers currently offer a format conversion policy that can be applied to an object storage bucket and set to convert the format of the object in the cloud during the performance of an upload function or during a download function (also referred to, herein, as an upload/download operation). Embodiments recognize that user requests to upload objects to COS or download objects from COS require manually locating object format converter modules, selecting the conversion formats, and submitting the resulting converted format object to an upload function to store the reformatted object in a selected storage bucket with the cloud environment. The current process is inefficient, requires redundant actions across a base of multiple users, risks inconsistency in object storage format, and may involve acquiring multiple licenses or access fees and authorizations. In addition, the current object format conversion process relies on the access and availability of an appropriate converter module.

Embodiments of the present invention also recognize similar issues and shortcomings related to the download functions of objects from COS. Performance of object format conversion currently occurs subsequent to download operations from COS, and includes similar requirements of availability, access, and use of an appropriate converter module, required of each instance of user and function. Embodiments also recognize that COS of multiple instances of one object, each having a different format to accommodate hardware or software compatibility needs (i.e., object1.gif, object1.bmp, object1.tif, etc.), risks inconsistency across the instances of the object if updates or modifications are made only to one instance of the object of a particular format. No linkage or detection currently exists that would protect consistency among instances of an object stored in various formats if one instance were modified or updated.

Embodiments also recognize that the performance of object format conversion on an individual user basis prevents recognition of incompatible format conversions and hinders the development and improvement of format conversions over time.

Embodiments of the present invention recognize that conversion of an object of a particular format to multiple instances of the object, each in a different format and designated for storage upload to COS, currently requires multiple separate operations of conversion.

Embodiments of the present disclosure include a system, computer-implemented method, and computer program product that are configured to generate a conversion policy that provides for an object having a first format to be converted to the object having a target format in which the target format is based on the conversion policy. In embodiments, the object format is converted within the COS environment and the format to which the object is converted is based on a conversion policy that corresponds to a storage bucket of the COS environment and the storage function performed on the object (i.e., an upload of the object to COS or a download of the object from COS). In embodiments, an authorized user may set the conversion policy and a conversion policy may apply at the storage-bucket level to one or more storage buckets with the COS environment.

In embodiments, the conversion of an object format is triggered by the detection of an upload or download function request for the object. Embodiments trigger the performance of an object format conversion prior to performing cloud storage processing operations for an upload function. For example, the object format conversion is performed prior to encrypting and indexing an object and storing the object in a storage bucket of the COS environment for an object upload function. In embodiments of the present invention, for download function requests, cloud storage processing operations, such as accessing and decrypting an object from a storage bucket are performed before conversion of the object format to a target format, while still within the COS environment. In embodiments for a download function request, the converted object having a target format is then delivered to the requesting device from the cloud environment, for example, by a cloud environment managing server. In embodiments, the format of the object stored in the COS bucket remains in the same format for download function requests, while a copy of the object is converted to a designated target format prior to download delivery from the COS environment. In some embodiments, the format conversions performed on objects during upload function operations will be persistent, whereas format conversions performed on objects during download function operations are applicable only for that operation.

In an embodiment in which a conversion policy is applied to an existing bucket including existing stored objects, the conversion operations will be performed for the existing objects, subject to the conversion policy and, additionally, the conversion will be applied as other objects are subsequently uploaded.

Embodiments of the present invention provide improvement by increased efficiency of an inclusive operation of performing format conversion of an object within the COS environment in combination with upload or download functions. Embodiments generate a conversion policy that includes a user selection of target format(s), applied to function operations (ie., upload/download), and applied to designated storage bucket(s) of a COS environment. The enabled conversion policy establishes consistency of format conversion of “any to one,” dynamically removing issues of consistency, and eliminating separate, manual conversion steps associated with multiple formats for object operations, such as incompatibility, the requirement of additional or more flexible hardware and/or software, and issues with inconsistent technical properties associated with objects of different formats. Embodiments improve the flexibility of object storage by enabling format conversion of “one-to-many,” providing multiple instances of an object having multiple formats, respectively, potentially serving a user group with diverse compatibility needs.

Embodiments provide improvement in which the conversion policy applied to download functions can produce a consistent retrieval format or required format for subsequent object utilization without altering the stored object format.

Embodiments provide a conversion policy that enables users to set hard-linked conversion while enabling cloud object storage for a “one-to-many” conversion in the object conversion policy. Hard-linked conversion results in linking information, included during the conversion of objects and maintained as part of an object's metadata, which identifies the linkage of the plurality of objects. Embodiments including hard-linked objects in object storage are alerted by the detection of user and system operations on objects in buckets with conversion policies that include hard-linked object checks. Embodiments check information included in the metadata associated with objects on which an operation is to be performed to determine whether the object is hard-linked to other objects, before taking action on the objects. In some embodiments, triggering and confirming linkage information enables servers and/or users managing cloud object storage to maintain awareness of the consistency of linked objects across all instances of the object having various formats, prior to performing actions on one or more of the object instances. A managing server checks on object linkage information, included in the metadata, before performing actions on the object and may provide an alert or warning informing a user or system operations of the linked objects, and may offer options or, in other embodiments, the conversion policy may direct actions to maintain object consistency across multiple formats, (i.e., identifying the hard-linked object instances).

An aspect of the disclosure includes a conversion module that identifies a request for an upload of an object to cloud object storage or download of an object from cloud object storage and triggers object format conversion based on a previously established conversion policy. The conversion module acts as a driver to invoke the appropriate converter(s) based on the established conversion policy, which may apply to one or more storage buckets of the cloud environment.

An aspect of the disclosure includes performing an “any-to-one” conversion applied to upload request operations, in which multiple objects having multiple format types, respectively, are received by the cloud environment and the multiple format types are converted from their respective original format to a single target format, prior to processing the respective objects into a designated storage bucket, and according to the conversion policy associated with the designated storage bucket.

An aspect of the disclosure includes performing the object format conversion for both upload and download function requests within the COS environment. The performance of object format conversion within the resources of the cloud environment provides an advantage of eliminating the need for users to manually access and perform conversion before upload functions or subsequent to receipt of the object from download functions.

An aspect of the disclosure includes an error-handling mechanism for incompatible format detection. In some embodiments, an object format detected during an upload or download request of cloud object storage is determined to be incompatible with conversion types recognized by the conversion policy for an object storage bucket. The disclosure includes a set of actions presented for a selection by the requesting user as a result of the detected incompatible conversion. The actions for selection may be set during conversion policy implementation and may, for example, include options to skip the operation (ignore), delete the object, or move the storage of the object to a particular storage bucket. The error-handling mechanism provides the advantage of identifying incompatible formats as recognized by the conversion policy and offers an opportunity to broaden conversion policy coverage.

An aspect of the disclosure includes the definition and rules associated with a conversion policy to be set by an authorized user and includes the assignment of the conversion policy to one or more object storage buckets within the cloud object storage environment. Conversion policies can designate what actions to take for conversion of a one-to-one object format conversion, an “any-to-one” object format conversion, or a “one-to-many” object format conversion. Embodiments trigger the performance of the object format conversion operation within the cloud environment, prior to storage processing for upload requests and subsequent to the storage process, and before download delivery of the converted object(s).

In some embodiments, the COS environment includes functional components that perform the processing of objects uploaded to cloud object storage or accessed from storage and downloaded to a requesting device. The functional components typically include a manager component (i.e., cloud managing server). A COS manager provides a management interface that is used for administrative tasks, such as system configuration, storage provisioning, and monitoring the performance and health of the system. In some embodiments, the manager can be deployed as a physical appliance, a virtual machine, or a Docker container. The COS system often includes a prep-component node that encrypts and encodes data on write operations and decodes and decrypts data on read operations. The component presents the storage interfaces to the client applications and transforms data often by the use of an Information Dispersal Algorithm (IDA). The component can be deployed as a physical appliance, VMware virtual machine, or Docker container

The COS system typically includes a storage component node that is responsible for segmenting and storing the data slices, usually with redundancy for backup. It receives data from the prep-component node on write operations and returns data to the prep-component node as required by read operations. The storage component also ensures the integrity of the saved data and rebuilds if necessary. Embodiments of the present invention propose the deployment of a conversion module triggering the conversion of object formats as directed by the conversion policy, based on the COS architecture and implementation strategy. Some embodiments may be deployed on a prep-component node of the COS environment, whereas other embodiments may be deployed on containers at runtime in an on-demand basis. Embodiments of the present invention trigger conversion of an existing object format to a target format, based on available appropriate convertors and the conversion policy set by an authorized user.

The aforementioned advantages are example advantages, and not all advantages are discussed. Furthermore, embodiments of the present disclosure can exist that contain all, some, or none of the aforementioned advantages while remaining within the spirit and scope of the present disclosure.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

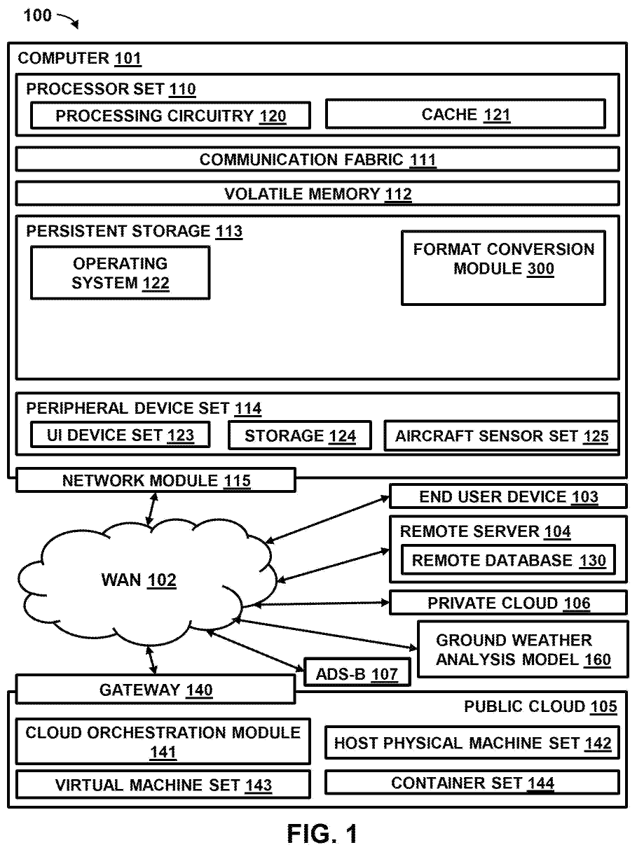

FIG. 1 depicts computing environment 100 containing an example of an environment for the execution of at least some of the computer code involved in performing the inventive methods, such as format conversion module 300. In addition to format conversion module 300, computing environment 100 includes, for example, computer 101, wide area network (WAN) 102, end-user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smartphone, smartwatch or other wearable computer, mainframe computer, quantum computer, or any other form of computer or mobile device now known or to be developed in the future that is capable of running a program, accessing a network or querying a database, such as remote database 130. As is well understood in the art of computer technology, and depending upon the technology, the performance of a computer-implemented method may be distributed among multiple computers and/or between multiple locations. On the other hand, in this presentation of computing environment 100, a detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby affect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct the performance of the inventive methods. In computing environment 100, at least some of the instructions for performing the inventive methods may be stored in format conversion module 300 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports, and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that are now known or to be developed in the future. The non-volatility of this storage means that the stored data is maintained regardless of whether power is being supplied to computer 101 and/or directly to persistent storage 113. Persistent storage 113 may be a read-only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in the representative block of format conversion program 300 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smartwatches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer, and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs, and manages active instantiations of VCE deployments. Gateway 140 is the collection of computer software, hardware, and firmware that allows public cloud 105 to communicate through WAN 102.

Some further explanations of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community, or public cloud types), often respectively implemented by different vendors.

Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

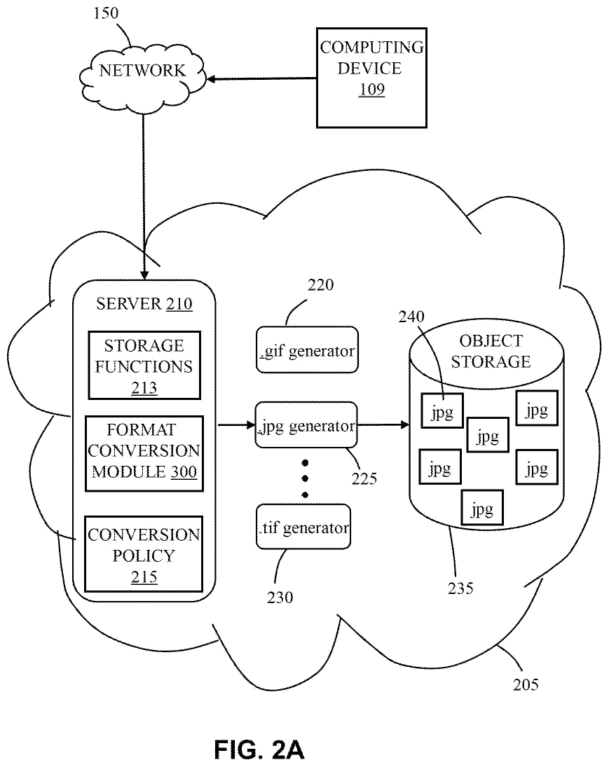

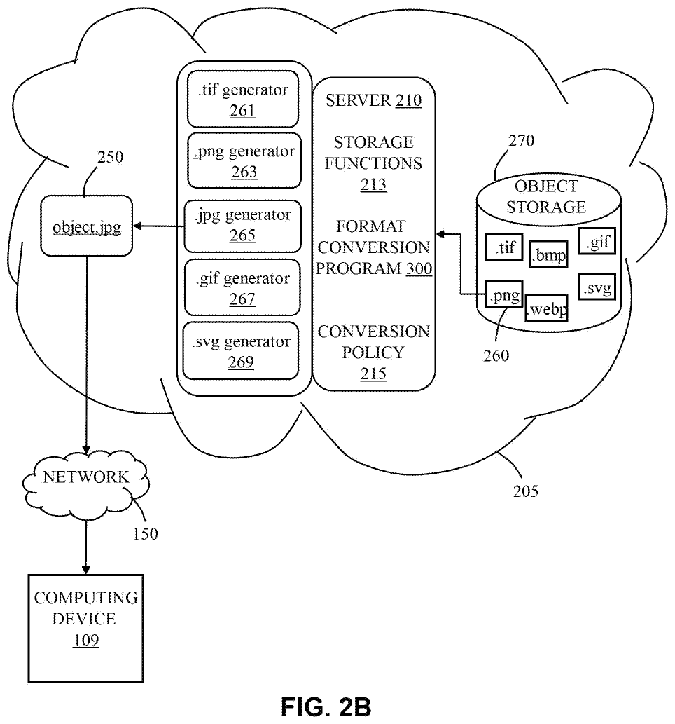

Referring now to FIG. 2A. FIG. 2A depicts a block diagram illustrating an example of object format conversion components within a cloud object storage environment for an upload function, in accordance with some embodiments of the present disclosure. FIG. 2A includes computing device 109, cloud server 210, format generators 220, 225, and 230, object storage bucket 235, stored object 240, cloud environment 205, and network 150 providing user access to application programming interfaces (APIs) of cloud server 210 of cloud environment 205. In some embodiments, the connection between cloud server 210 and computing device 109 includes the use of representational state transfer (REST) calls. In some embodiments, computing device 109 is a user device communicatively connected to cloud environment 205 via network 150. In some embodiments, an authorized user of computing device 109 provides input to set rules for a conversion policy, defining format conversion actions or conversion options for upload and download functions directed to object storage bucket 235 of cloud environment 205. In some embodiment, users of computing device 109 and users of similar devices (not shown) submit requests for object upload and download to APIs or REST calls to cloud server 210.

In some embodiments, a user of computing device 109 includes the input of conversion formats to recognize and one or more target formats for object format conversion. The user may further designate whether “any-to-one” or “one-to-many” options are included in the conversion policy. In embodiments, the user designates the conversion policy information that applies to upload functions and the conversion policy information that applies to download operations. The conversion policy information includes rules that define the format conversion actions applied to upload and/or download functions. The conversion policy is generated based on the rules input by the authorized user. Additionally, the conversion policy is designated to apply to one or more object storage buckets of the cloud environment.

In some embodiments, the user inputs hard-linkage instructions for metadata of objects indicating linkage between stored objects. In some embodiments, the authorized user of computing device 109 defines actions and/or options for error handling of object formats determined to be incompatible for conversion. In one embodiment, users of computing device 109 submit requests for uploading one or more objects having respective formats to an API of cloud server 210 of cloud environment 205 for object storage in a designated storage bucket. In another embodiment, users of computing device 109 submit requests for downloading one or more objects stored in a storage bucket of cloud environment 205. In some embodiments, computing device 109 can be a laptop computer, a desktop computer, a virtual computer, a smartphone, a tablet computer, a server computer, or any computing device enabled to send, receive, and process data and instructions with cloud server 210 of cloud environment 205. In some embodiments, computing device 109 is similar in structure and function to end-user device 103 of FIG. 1.

Network 150 provides a communicative connection between computing device 109 and components of cloud environment 205, such as cloud server 210. Network 150 can be, for example, a local area network (LAN), a telecommunications network, a wide area network (WAN), such as the Internet, a virtual local area network (VLAN), or any combination that can include wired, wireless, or optical connections. In some embodiments, network 150 may be a wide area network (WAN) 102 depicted in FIG. 1. In general, network 150 can be any combination of connections and protocols that will support data transmission and communications between computing device 109 and components of cloud environment 205.

Cloud environment 205 includes cloud server 210, format generators 220, 225, and 230, and object storage bucket 235. Cloud environment 205 includes computer systems and components available for use by multiple entities and provides on-demand availability of computer system resources and/or other computer capabilities, especially data storage (cloud storage) and computing power, without direct active management by the user. In some embodiments, cloud environment 205 may be a public cloud, similar to public cloud 105 of FIG. 1. In other embodiments, cloud environment 205 may be a private cloud or exist as a hybrid cloud environment, having combinations of user-owned, public cloud, and private cloud components. Embodiments of the present invention include the use of upload and download functions of cloud environment 205 for format conversion of objects stored or to be stored in COS.

Cloud server 210 includes storage functions 213, format conversion module 300, and conversion policy 215, as well as one or more user interfaces (not shown). In some embodiments, cloud server 210 can be a laptop computer, a desktop computer, a mobile computing device, or other programmable electronic device or computing system capable of receiving, sending, and processing data. In other embodiments, cloud server 210 may be a stand-alone computing device interacting with applications and services hosted and operating in cloud environment 205. In still other embodiments, cloud server 210 may be a blade server, a web-based server computer, or be included in a computing system utilizing clustered computers and components (e.g., database server computers, application server computers, etc.) that act as a single pool of seamless resources when accessed within distributed data processing environment 100. In yet other embodiments, cloud server 210 can be a netbook computer, or other programmable electronic device capable of receiving data from and communicating with components of cloud environment 205 and computing device 109. Cloud server 210 may include internal and external hardware components, depicted in FIG. 1.

Storage functions 213 operate from cloud server 210 and include applications and functions to maintain and monitor cloud environment 205. Storage functions 213 include functions and operations to prepare and execute storage of objects into a designated storage bucket of COS, as well as functions and operations to retrieve, copy, decrypt, and prepare an object for download, for example.

Format conversion module 300 generates a conversion policy, such as conversion policy 215, based on input from an authorized user setting rules that define the conversion actions and conditions of the conversion policy. The conversion policy input includes the identification of one or more starting (i.e., original) object formats and designating one or more conversion object formats, also referred to as a/the target format(s). Format conversion module 300 includes in the conversion policy the initial (i.e., starting) object formats acceptable for conversion and the target object formats resulting from conversion for upload functions to COS and for download functions from COS of the cloud environment. In some embodiments, the conversion policy designations may be different for upload functions and download functions. In some embodiments, the conversion policy includes selectable format conversion options. In embodiments, the conversion policy may be applied to a particular object storage bucket or multiple object storage buckets.

Format conversion module 300 triggers one or more appropriate converters of object formats to perform a format conversion based on a conversion policy that corresponds to one or more object storage buckets of cloud environment 205. Reception of a request for download or upload of an object by an API or REST call to cloud server 210 initiates format conversion module 300 to trigger performance of object format conversion within cloud environment 205. In an embodiment, format conversion module 300 triggers (i.e., initiates) an object format conversion by an appropriate format converter, based on conversion policy 215, subsequent to receipt of the object within cloud environment 205 for an upload function, and prior to preparation for storage in a designated object storage bucket. In an embodiment, format conversion module 300 triggers the conversion of the format of an object retrieved (i.e., copied) from an object storage bucket of cloud environment 205 for a download function, subsequent to preparation of the copy of the object for download and prior to delivery of the download operation.

Format conversion module 300 determines the format of an object included in a request for upload to COS or download from COS. Format conversion module 300 determines the conversion format based on conversion policy 215 and initiates an appropriate conversion generator (i.e., .jpg generator 225 for image format conversion, FIG. 2A), to perform the conversion within cloud environment 205. Format conversion module 300 initiates the object format conversion at a point dependent on the function being performed, such as an upload function or a download function. Format conversion module 300 triggers the object format conversion to be performed for an upload function after receipt of the object within cloud environment 205 and prior to storage preparation by storage functions 213. Format conversion module 300 triggers the object format conversion to be performed for a download function after the object is retrieved and prepared for download by storage functions 213, and prior to the download operation sending the object with the converted format to, for example, computing device 109.

In some embodiments, format conversion module 300 triggers conversion of “any-to-one” object format conversions. In another embodiment, format conversion module 300 triggers a “one-to-many” conversion of object formats, or in yet another embodiment, format conversion module 300 triggers one-to-one object formats. In some embodiments, format conversion module 300 includes hard-link data of a plurality of objects having different respective formats resulting from a “one-to-many” conversion. The hard-linked data is included in the respective metadata of the plurality of converted objects. When hard-linking of format-converted objects is enabled for a “one-to-many” conversion operation, the converted objects with respective formats are linked. An update or other operation that is performed on any of the linked objects the operation will be applied to all of the other objects to which it is linked. In some embodiments, a soft-linked conversion can be performed, based on the conversion policy, in which objects resulting from a conversion operation are not linked. In such cases, an operation performed on one of the “one-to-many” objects will not affect the other objects. In some embodiments, format conversion module 300 includes an error handling function that may provide options of action to take as a result of determining an object format conversion incompatibility.

Conversion policy 215 includes user-designated object format conversions for upload functions and download functions and may be applied to one or more storage buckets, such as object storage bucket 235, within cloud environment 205. Conversion policy 215 includes the identification of initial object formats and corresponding conversion formats, which may be a “one-to-one” conversion, a “one-to-many” conversion, or an “any-to-one” conversion. Conversion policy 215 may include information in the metadata of converted format objects to maintain a hard linkage between multiple instances of one object each with a different format so that a check is performed to determine linkages between objects before operations or actions are performed on one of the instances of the object.

Format generators 220, 225, and 230 represent conversion-specific applications, modules, or tools that are included in cloud environment 205 or accessible to components of cloud environment 205 and perform actual object format conversions which are triggered by format conversion module 300 and directed according to conversion policy 215. Format generator 220 is depicted as converting an image object format as received to a “.gif” format, for example. Similarly, conversion generator 225 converts a received image object format to a “.jpg” format, and format generator 230 converts the received image object format to a “.tif” format. FIG. 2A depicts that additional format generators may be included within cloud environment 205. In some embodiments format conversion module 300 initiates a conversion utilizing a single converter, such as format generator 225. In other embodiments, multiple converters may be initiated to generate multiple instances of the subject object, each having a different respective format, based on conversion policy 215.

Object storage bucket 235 depicts a storage bucket within cloud environment 205 and includes multiple image objects having a “jpg” format, such as stored object 240. In some embodiments, object storage bucket 235 includes various objects that originally included various respective formats, which were converted during upload function operations within cloud environment 205 to a single consistent format (.jpg). In other embodiments, object storage bucket 235 may include multiple instances of a particular object, and the instances of the object may have a variety of formats, respectively, based on the conversion policy applied to object storage bucket 235, such as conversion policy 215.

Stored object 240 is an object stored in object storage bucket 235 that has been converted from an original object format to a .jpg format.

FIG. 2B is a block diagram illustrating an example of object format conversion within a cloud storage environment for an object download function, in accordance with some embodiments of the present disclosure. FIG. 2B includes computing device 109, object.jpg 250 format conversion generators 261, 263, 265, 267, and 269, cloud server 210, object storage bucket 270, and network 150 providing user access to cloud server 210 and components of cloud environment 205.

Computing device 109, network 150, cloud environment 205, cloud server 210, and storage functions 213, format conversion module 300, and conversion policy 215 are similar in representation and function as detailed above regarding FIG. 2A. Object.jpg 250 results from the format conversion of an image object of a “.png” format to a format of “.jpg”. Object.png 260 is identified in a request for download of the object, received by cloud server 210 operating within cloud environment 205 and requested from computing device 109, which is connected to cloud environment 205 via network 150. In embodiments, receipt of the download request initiates storage functions 213 to locate and retrieve object.png 260 in object storage bucket 270 and perform additional functions that may be required to enable download, such as decryption of the stored object.

Format conversion module 300 is initiated by the download request of object.png 260 from object storage bucket 270. Format conversion module 300 triggers an appropriate conversion generator (i.e., .jpg generator 265) to perform the conversion of object.png 260 to object.jpg 250, which is performed subsequent to the completion of storage functions 213 on object.png 260 and before the download delivery from cloud environment 205 to computing device 109, via network 150. In some embodiments, object storage bucket 270 includes a plurality of objects, which may have multiple formats, respectively. Format conversion module 300 accesses conversion policy 215 to determine the appropriate format conversion to perform on the object identified in the download request. In an embodiment, format conversion module 300 determines the format of the object in storage, which is requested for download, and determines the conversion target format in conversion policy 215 designating the conversion format of the object retrieved from object storage bucket 270.

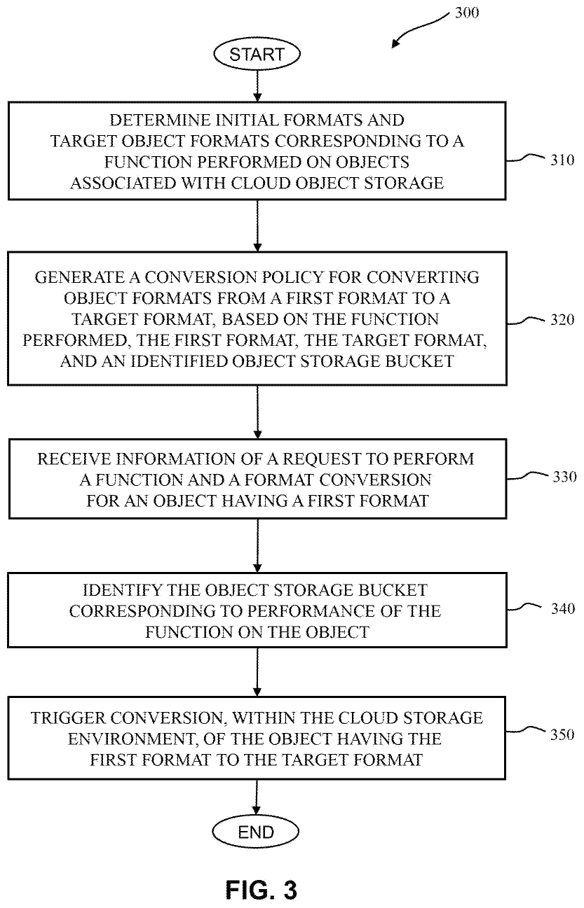

FIG. 3 illustrates an example process flow for object format conversion by format conversion module 300, within a cloud storage environment, in accordance with some embodiments of the present disclosure. The process may be a computer-implemented process performed by program instruction and/or logic that comprises hardware (e.g., circuitry, dedicated logic, programmable logic, microcode, etc.), software (e.g., program instructions run on a processor), firmware, or a combination thereof. In embodiments, the process may be performed by processor set 110 of computer 101, depicted in FIG. 1.

In embodiments, format conversion module 300 determines initial formats and target object formats corresponding to a function performed on objects associated with cloud object storage (step 310). In some embodiments, for a cloud object storage environment, a user identifies and inputs to format conversion module 300, the object formats that will be recognized by format conversion module 300 as initial object formats. In some embodiments, format conversion module 300 receives input for a target format (or target formats for “one-to-many” format conversions). The initial object formats will include the formats recognized by format conversion module 300 and to which a corresponding target format conversion is designated.

For example, for cloud environment 205, format conversion module 300 determines the initial object formats submitted by a user operating on computing device 109. Format conversion module 300 determines that the submitted list of object image formats includes .png, .tif, .svg, gif, and .bmp, as initial object formats that are recognized. Format conversion module 300 determines a target object format submitted, such as .jpg, for conversion of objects with any of the initial formats to an object of a .jpg format. Format conversion module 300 determines that the designated conversion applies to an upload function of objects to COS. Format conversion module 300 determines initial formats and target formats for download functions from COS.

Format conversion module 300 generates a conversion policy for converting object formats from a first format to a target format, based on the function performed, the first format, the target format, and an identified object storage bucket (step 320). The conversion policy is aligned with a function, such as an upload function of an object to an object storage bucket within a cloud environment. Alternatively, the conversion policy may be aligned with a download function of an object stored within an object storage bucket of a cloud environment. The conversion policy includes object formats of an initial or original state of the object from which the object will be converted to a target format. In some embodiments, the conversion policy includes an “any-to-one” conversion, which would convert objects of any received format (i.e., any recognized format) to a designated target format, for the specified function performed on the object, such as an upload to COS. It should be noted that the “any” aspect of the conversion policy is dependent on the converters or conversion generators made available to the cloud object storage environment and the initial or original format recognized by the conversion generators. In some embodiments, the conversion policy may include a “one-to-many” format conversion in which an object of a particular format is converted into multiple instances of the object, each having different formats.

For example, format conversion module 300 generates a conversion policy for an upload function in which a set of object formats for initial or original format state include .png, .tif, .bmp, .svg, and .gif. The generated conversion policy designates that objects with formats included in the set of initial object formats are to be converted to a .jpg format. Additionally, format conversion module 300 includes in the generation of the conversion policy, an error handling component for object formats that are not included in the initial or original format set, and provides an alert, action options to take, or may abort the upload request.

Format conversion module 300 detects a request to perform a format conversion connected to a function for a object having a first format (step 330). In some embodiments, a request for performing a function on an object is received by an API or REST call of a managing or controlling server operating within the cloud storage environment. The request identifies the function to be performed and includes an object having a particular format. In some embodiments, the request may include information confirming the performance of a format conversion associated with the function. Embodiments include the designation of an upload function or a download operation as the function. In some embodiments, the received request to perform the function on the object includes information enabling format conversion module 300 to determine an object storage bucket associated with the requested function.

For example, format conversion module 300 detects a request received by an API of cloud server 210 operating within cloud environment 205. Format conversion module 300 receives information identifying the requested function as a download function and the object and corresponding format to be downloaded.

Format conversion module 300 identifies an object storage bucket corresponding to the performance of the function on the object (step 340). Format conversion module 300 identifies the object storage bucket in which the object of the requested function is stored, for a download function performed on the received object. For an upload function, format conversion module 300 receives information regarding the object storage bucket in which the uploaded object is designated to be stored, based on information provided by a managing server of the cloud environment, for example.

Format conversion module 300 triggers conversion, within the cloud storage environment, of the object having the first format to the target format (step 350). Format conversion module 300 triggers the conversion of the object from the original format to the target format by initiating a format conversion generator that provides the appropriate format conversion, based on the conversion policy that corresponds to the identified object storage bucket. Format conversion module 300 performs the format conversion of an upload function within the cloud storage environment after the object is uploaded to the cloud storage environment and before the object is processed for storage and stored in an object storage bucket. Format conversion module 300 performs the format conversion of a download function after the object is copied from the object storage bucket and processed to prepare for the download operation, but prior to delivery of the format-converted object from the cloud storage environment to a receiving computing device. Format conversion module 300 performs the format conversion based on the conversion policy corresponding to the object storage bucket associated with the upload or download function indicated in the received request.

For example, format conversion module 300, having determined that the received information indicated an upload function of an object having a first format of .png and designated to be stored in object storage bucket 235, triggers the conversion of the object by a conversion generator, such as format generator 225. Format conversion module 300 accesses the conversion policy associated with object storage bucket 235 to determine the set of original object formats recognized and the target format for object storage bucket 235. Format conversion module 300 recognizes the .png format as included in the set of original object formats recognized by the conversion policy and that the .jpg format is the target format for object storage bucket 235. Format conversion module 300 initiates the appropriate conversion generator (i.e., format generator 225) to convert the object having the first format to the target format of jpg. The format conversion module 300 determines that the performance of the conversion occurs within cloud environment 205 prior to additional processing by storage functions 213 and storage of the object having a target format in object storage bucket 235.

Having completed a format conversion associated with the requested function, format conversion module 300 ends.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium or media, as the terms are used in the present disclosure, are not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

It is to be understood that although this disclosure includes a detailed description of cloud computing, implementation of the teachings recited herein is not limited to a cloud computing environment. Rather, embodiments of the present disclosure are capable of being implemented in conjunction with any other type of computing environment now known or later developed.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatuses, or another device to cause a series of operational steps to be performed on the computer, other programmable apparatus, or another device to produce a computer-implemented process, such that the instructions which execute on the computer, other programmable apparatuses, or another device implement the functions/acts specified in the flowchart and/or block diagram block or blocks.

The flowcharts and/or block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or act or carry out combinations of special purpose hardware and computer instructions.

The terminology used herein is to describe particular embodiments only and is not intended to limit the present disclosure. As used herein, the singular forms “a”, “an” and “the” are intended to include the plural forms as well, unless the context clearly indicates otherwise. It will further be understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The corresponding structures, materials, acts, and equivalents of all means or steps plus function elements in the claims below are intended to include any structure, material, or act for performing the function in combination with other claimed elements, as specifically claimed. The description of the present disclosure has been presented for purposes of illustration and description but is not intended to be exhaustive or limited to the present disclosure in the form disclosed. Many modifications and variations will be apparent to those of ordinary skills in the art without departing from the scope of the present disclosure. The embodiments are chosen and described in order to explain the principles of the present disclosure and the practical application, and to enable others of ordinary skills in the art to understand the present disclosure for various embodiments with various modifications, as are suited to the particular use contemplated.

The corresponding structures, materials, acts, and equivalents of all means or steps plus function elements in the claims below are intended to include any structure, material, or act for performing the function in combination with other claimed elements, as specifically claimed. The description of the present disclosure has been presented for purposes of illustration and description but is not intended to be exhaustive or limited to the present disclosure in the form disclosed. Many modifications and variations will be apparent to those of ordinary skills in the art without departing from the scope of the present disclosure. The embodiments are chosen and described in order to explain the principles of the present disclosure and the practical application, and to enable others of ordinary skills in the art to understand the present disclosure for various embodiments with various modifications, as are suited to the particular use contemplated.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

For example, without limitation, “at least one of item A, item B, or item C” may include item A, item A and item B, or item B. This example also may include item A, item B, and item C, or item B and item C. Of course, any combinations of these items can be present. In some illustrative examples, “at least one of” can be, for example, without limitation, two of item A; one of item B; and ten of item C; four of item B and seven of item C; or other suitable combinations.

Different instances of the word “embodiment” as used within this specification do not necessarily refer to the same embodiment, but they may. Any data and data structures illustrated or described herein are examples only, and in other embodiments, different amounts of data, types of data, fields, numbers, and types of fields, field names, numbers and types of rows, records, entries, or organizations of data may be used. In addition, any data may be combined with logic, so that a separate data structure may not be necessary. The previous detailed description is, therefore, not to be taken in a limiting sense.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present invention has been described in terms of specific embodiments, it is anticipated that alterations and modifications thereof will become apparent to the skilled in the art. Therefore, it is intended that the following claims be interpreted as covering all such alterations and modifications as fall within the true spirit and scope of the invention.

What is claimed is:

1. A computer-implemented method for cloud object storage format conversion, the method comprising:
a processor identifying a target format for an object and an object storage bucket for object storage in a cloud environment;
the processor determining a function associated with objects stored in the object storage bucket of the cloud environment,
the processor generating a conversion policy for the object storage bucket, wherein the conversion policy includes converting the object from a first format to the target format, based at least in part on the function;
the processor receiving a request to perform the function for the object having the first format; and
responsive to determining that the first format and the target format are different formats, the processor triggering a conversion of the object having the first format to the target format within the cloud environment, based on the function requested and the conversion policy for the object storage bucket.

2. The method of claim 1, wherein the conversion policy for the object storage bucket includes input from a user setting conversion policy rules.

3. The method of claim 1, wherein the conversion of the object from the first format to the target format occurs subsequent to processing the object for the function of a download operation, and the conversion of the object from the first format to the target format occurs prior to processing the object for object storage in the object storage bucket for the function of an upload operation.

4. The method of claim 1, wherein the target format is a plurality of formats and the conversion of the object having the first format generates one-to-many formats corresponding to a plurality of instances of the object with respective format types, based on the conversion policy for the object storage bucket of the cloud environment.

5. The method of claim 1, wherein the first format includes a plurality of objects having a plurality of formats, respectively, and a conversion of the plurality of objects generates the plurality of objects with the target format, respectively, based on the conversion policy for the object storage bucket of the cloud environment.

6. The method of claim 4, further comprising:
the processor creating a hard-linking of the plurality of instances of the object with the respective format types from the one-to-many formats conversion of the object by metadata associated with each instance of the plurality of instances of the object; and
the processor triggering a performance of an operation on each of the hard-linking of the plurality of instances of the object with the respective format types by detection of the performance of the operation on one of the instances of the object with respective format types.

7. The method of claim 1, wherein the function requested is a download request, and a format type for the conversion of the object having the first format is included in the download request and performed within the cloud environment prior to performing the download.

8. A computer system for cloud object storage format conversion, the system comprising:
a processor; and
a computer-readable storage medium communicatively coupled to the processor and storing program instructions which, when executed by the processor, cause the processor to perform a method comprising:
identifying a target format for an object and an object storage bucket for object storage in a cloud environment;
determining a function associated with objects stored in the object storage bucket of the cloud environment,
generating a conversion policy for the object storage bucket, wherein the conversion policy includes converting the object from a first format to the target format, based at least in part on the function;
receiving a request to perform the function for the object having the first format; and
responsive to determining that the first format and the target format are different formats, the processor triggering a conversion of the object having the first format to the target format within the cloud environment, based on the function requested and the conversion policy for the object storage bucket.

9. The computer system of claim 8, wherein the conversion policy for the object storage bucket includes input from a user setting conversion policy rules.

10. The computer system of claim 8, wherein the conversion of the object from the first format to the target format occurs subsequent to processing the object for the function of a download operation, and the conversion of the object from the first format to the target format occurs prior to processing the object for object storage in the object storage bucket for the function of an upload operation.

11. The computer system of claim 8, wherein the target format is a plurality of formats and the conversion of the object having the first format generates one-to-many formats corresponding to a plurality of instances of the object with respective format types, based on the conversion policy for the object storage bucket of the cloud environment.

12. The computer system of claim 8, wherein the first format includes a plurality of objects having a plurality of formats, respectively, and triggering of a conversion of the plurality of objects generates the plurality of objects with the target format, respectively, based on the conversion policy for the object storage bucket of the cloud environment.

13. The computer system of claim 11, further comprising:
creating a hard-linking of the plurality of instances of the object with the respective format types from the one-to-many formats conversion of the object, based on the conversion policy, wherein metadata associated with each of the plurality of instances of the object maintains information of the hard-linking; and
triggering a performance of an operation on each of the hard-linking of the plurality of instances of the object with the respective format types by detection of the performance of the operation on one of the instances of the object with respective format types.

14. The computer system of claim 8, wherein the function requested is a download request, and a format type for the conversion of the object having the first format is included in the download request and performed within the cloud environment prior to performing the download.

15. A computer program product for cloud object storage format conversion, the computer program product comprising:
at least one computer-readable storage medium; and program instructions stored on the at least one computer-readable storage medium, the program instructions comprising:
program instructions to identify a target format for an object and an object storage bucket for object storage in a cloud environment;
program instructions to determine a function associated with objects stored in the object storage bucket of the cloud environment,
program instructions to generate a conversion policy for the object storage bucket, wherein the conversion policy includes converting the object from a first format to the target format, based at least in part on the function;
program instructions to receive a request to perform the function for a object having the first format; and
responsive to determining that the first format and the target format are different formats, program instructions to trigger a conversion of the object having the first format to the target format within the cloud environment, based on the function requested and the conversion policy for the object storage bucket.

16. The computer program product of claim 15, wherein the conversion policy for the object storage bucket includes input from a user setting conversion policy rules.

17. The computer program product of claim 15, wherein the function is a download operation and includes conversion of the object having the first format to the target format within the cloud environment subsequent to processing the object for the download operation.

18. The computer program product of claim 15, wherein the conversion of the object from the first format to the target format occurs subsequent to processing the object for the function of a download operation, and the conversion of the object from the first format to the target format occurs within the cloud environment prior to processing the object for object storage in the object storage bucket for the function of an upload operation.

19. The computer program product of claim 15, wherein the first format includes a plurality of objects having a plurality of formats, respectively, and a conversion of the plurality of objects generates the plurality of objects with the target format, respectively, based on the conversion policy for the object storage bucket of the cloud environment.

20. The computer program product of claim 18, further comprising:
program instructions to create a hard-linking of the plurality of instances of the object with the respective format types from the one-to-many formats conversion of the object, based on the conversion policy, wherein metadata associated with each of the plurality of instances of the object maintains information of the hard-linking; and
program instructions to trigger a performance of an operation on each of the linked plurality of instances of the object with the respective format types by detection of the performance of the operation on one of the instances of the object with respective format types.
